(19) United States
(12) Patent Application Publication
(10) Pub. No.: US 2004/0198318 A1
(43) Pub. Date: Oct. 7, 2004

(54) Security deciphering apparatus for enciphered data transmitted over public network and security deciphering method using the same

(75) Inventor: Hoe-Won Kim, Seoul (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., GYEONGGI-DO (KR)

(21) Appl. No.: 10/754,802

(22) Filed: Jan. 9, 2004

(30) Foreign Application Priority Data
Jan. 10, 2003 (KR) P2003-1734

(51) Int. Cl. H04M 3/16

(52) U.S. Cl. 455/410; 455/411

(57) ABSTRACT

Disclosed is a security deciphering apparatus including a hidden secret key storing unit for storing a hidden secret key (Kh) corresponding to intrinsic identification information, a first decoding unit for receiving a personal secret key ({Ks}Kh), generated by enciphering a cipher key (Ks) by using the hidden secret key (Kh), via a public network, and decoding the personal secret key ({Ks}Kh) by using the hidden secret key (Kh), thereby obtaining the cipher key (Ks), and a second decoding unit for receiving enciphered data ({M}Ks), generated by enciphering data (M) by using the cipher key (Ks), via the public network, and decoding the enciphered data ({M}Ks) by using the cipher key (Ks), thereby obtaining the data (M). In accordance with the security deciphering apparatus, it is possible to receive data while maintaining a desired security of the data.

### PRIORITY

This application claims priority to an application entitled “SECURITY DECIPHERING APPARATUS FOR ENCIPHERED DATA TRANSMITTED OVER PUBLIC NETWORK AND SECURITY DECIPHERING METHOD USING THE SAME” filed in the Korean Industrial Property Office on Jan. 10, 2003 and assigned Serial No. 2003-01734, the contents of which is incorporated herein by reference.

### BACKGROUND OF THE INVENTION

1. Field of the Invention

The present invention relates to a security deciphering apparatus and method, and more particularly to a security deciphering apparatus and method in which the data of a cipher key used to encipher data is obtained by decoding an enciphered version of the cipher key by using hidden identification (ID) information given to a terminal requesting the data, so that an improvement in security can be achieved even for data transmitted over public networks.

2. Description of the Related Art

In accordance with building of public networks including diverse wireless network and super-high speed communication networks, on-line sharing of a large quantity of data is currently possible. Currently, off-line data is widely shared using inexpensive large-capacity storage media such as CDs and DVDs. Thus, users can be provided with numerous kinds of data shared on-line and off-line.

Although such on-line and off-line sharing systems can easily provide a large quantity of diverse data, commercially available security systems do not provide high levels of security.

In order to solve such poor security associated with data shared in on-line and off-line, service providers use a security system in which desired data is provided to terminals of authorized users, using a certain secure channel. There are two representative examples of data servicing systems using such a secure channel.

The first data servicing system is a system in which the service provider can provide data to the user via an exclusive secure channel after communicating with the terminal of the user to perform an authentication procedure. However, this system has a problem in that the above mentioned diverse on-line and off-line networks cannot be used, so that services can be provided only through an exclusive secure channel provided by the service provider. Since an authentication is required prior to providing desired services through an exclusive secure channel, inconvenience is caused to the user who desires to receive those services. Furthermore, a financial burden is imposed on the user for the utilization of the services.

The second data servicing system is a system in which data is enciphered to be readable only by the terminals of particular users and the data is provided over a general network. In accordance with this system, the users can receive enciphered data, using diverse methods. However, this system has a problem in that the service provider providing data services has to provide different cipher information to respective terminals of the users so that each cipher information is decipherable only by a corresponding one of the terminals. For this reason, the service provider must be equipped with a storage device for storing respective cipher information for all registered terminals such that they are distinguishable from one another. Furthermore, the service provider must be equipped with a communication device required to provide data services to the users over a general network. As a result, this system suffers from the disadvantages of high costs and low efficiency.

### SUMMARY OF THE INVENTION

Therefore, the present invention has been made in view of the above mentioned problems involved with the related art, and an object of the invention is to provide a data service providing apparatus capable of providing commercial data and secured data to users over public on-line and off-line networks while maintaining security of commercial data and secured data, a security deciphering apparatus capable of deciphering data provided using the data service providing apparatus, and a data service providing method using the data service providing apparatus.

Another object of the invention is to provide a data service providing apparatus which provides data enciphered using a cipher key along with an enciphered version of the cipher key decipherable only by the device requesting the data, thereby being capable of providing data while maintaining a desired security of the data, a security deciphering apparatus which is equipped in the data requesting device, and adapted to obtain the cipher key in accordance with a decoding operation for the enciphered cipher key, and a security deciphering method using the security deciphering apparatus.

In accordance with one aspect, the present invention provides a security deciphering apparatus comprising a hidden secret key storing unit for storing a hidden secret key (Kh) corresponding to intrinsic identification information; a first decoding unit for receiving a personal secret key ({Ks}Kh), generated by enciphering a cipher key (Ks) by using the hidden secret key (Kh), via a public network, and decoding the personal secret key ({Ks}Kh) by using the hidden secret key (Kh), thereby obtaining the cipher key (Ks); and a second decoding unit for receiving enciphered data ({M}Ks), generated by enciphering data (M) by using the cipher key (Ks), via the public network, and decoding the enciphered data ({M}Ks) by using the cipher key (Ks), thereby obtaining the data (M).

Preferably, the security deciphering apparatus further comprises a personal secret key storing unit, and a cipher key storing unit. The personal secret key storing unit stores the personal secret key ({Ks}Kh) received via the public network, and outputs the stored personal secret key ({Ks}Kh) to the first decoding unit under the control of the first decoding unit. The cipher key storing unit stores the cipher key (Ks) obtained by the first decoding unit, and outputs the stored cipher key (Ks) to the second decoding unit under the control of the second decoding unit.

In accordance with another aspect, the present invention provides a data service providing apparatus for providing data requested by a communication terminal, comprising a data database for storing data (M) to be provided to the communication terminal; a hidden secret key database for storing a hidden secret key (Kh) corresponding to intrinsic identification information of a security deciphering module equipped in the communication terminal to decipher enciphered data; a transmitting/receiving unit for performing communication with the communication terminal via a public network; a data enciphering unit for enciphering the data (M) by using a cipher key (Ks); a cipher key enciphering unit for enciphering the cipher key (Ks) by using the hidden secret key (Kh); and a control unit for controlling the enciphering operations of the data and cipher key enciphering units, and controlling the transmitting/receiving unit to provide the enciphered data ({M}Ks) and the personal secret key ({Ks}Kh) via the public network.

Preferably, the security deciphering module comprises a hidden secret key storing unit for storing the hidden secret key (Kh) corresponding to the intrinsic identification information of the security deciphering module, a first decoding unit for decoding the personal secret key ({Ks}Kh) provided by the transmitting/receiving unit, by using the hidden secret key (Kh), thereby obtaining the cipher key (Ks), and a second decoding unit for decoding the enciphered data ({M}Ks) provided by the transmitting/receiving unit, by using the cipher key (Ks), thereby obtaining the data (M).

The security deciphering module may comprise a personal secret key storing unit for storing the personal secret key ({Ks}Kh) provided by the transmitting/receiving unit, and outputting the stored personal secret key ({Ks}Kh) to the first decoding unit under a control of the first decoding unit, and a cipher key storing unit for storing the cipher key (Ks) obtained by the first decoding unit, and outputting the stored cipher key (Ks) to the second decoding unit under a control of the second decoding unit.

In accordance with another aspect, the present invention provides a security deciphering method comprising the steps of determining whether or not a personal secret key ({Ks}Kh) generated by enciphering a cipher key (Ks) by using a hidden secret key (Kh) corresponding to intrinsic identification information is received; if it is determined that the personal secret key ({Ks}Kh) is received, then decoding the received personal secret key ({Ks}Kh) by using the hidden secret key (Kh), thereby obtaining the cipher key (Ks); determining whether or not enciphered data ({M}Ks) generated by enciphering data (M) requested to be transmitted by using the cipher key (Ks) is received; and if it is determined that the enciphered data ({M}Ks) is received, then decoding the enciphered data ({M}Ks) by using the cipher key Ks, thereby obtaining the data (M).

In accordance with another aspect, the present invention provides a data service providing method for providing data requested by a communication terminal, comprising the steps of receiving a request for transmission of data (M) from the communication terminal via a public network; enciphering the data (M) by using a cipher key (Ks) in response to the received data transmission request, thereby generating enciphered data ({M}Ks); enciphering, in response to the received data transmission request, the cipher key (Ks) by using a hidden secret key (Kh) corresponding to intrinsic identification information assigned to a security enciphering module equipped in the communication terminal to decode the enciphered data ({M}Ks), thereby generating personal secret key ({Ks}Kh); and transmitting the enciphered data ({M}Ks) and the personal secret key ({Ks}Kh) to the communication terminal via the public network.

Preferably, the security enciphering module equipped in the communication terminal comprises a hidden secret key storing unit for storing the hidden secret key (Kh) corresponding to the intrinsic identification information assigned to the security enciphering module, a first decoding unit for decoding the personal secret key ({Ks}Kh) by using the hidden secret key (Kh), thereby obtaining the cipher key (Ks), and a second decoding unit for decoding the enciphered data ({M}Ks) by using the obtained cipher key (Ks), thereby obtaining the data (M).

The security deciphering module may further comprise a personal secret key storing unit for storing the personal secret key ({Ks}Kh) received by the communication terminal via the public network, and outputting the stored personal secret key ({Ks}Kh) to the first decoding unit under a control of the first decoding unit, and a cipher key storing unit for storing the cipher key (Ks) obtained by the first decoding unit, and outputting the stored cipher key (Ks) to the second decoding unit under a control of the second decoding unit.

In accordance with another aspect, the present invention provides in a mobile communication terminal receiving, via a public network, enciphered data ({M}Ks) generated by enciphering data (M) by using a cipher key (Ks), a security deciphering apparatus comprising a hidden secret key storing unit for storing a hidden secret key (Kh) corresponding to intrinsic identification information assigned to the mobile communication terminal; a first decoding unit for receiving a personal secret key ({Ks}Kh), generated by enciphering a cipher key (Ks) by using the hidden secret key (Kh), and decoding the personal secret key ({Ks}Kh) by using the hidden secret key (Kh), thereby obtaining the cipher key (Ks); and a second decoding unit for decoding the enciphered data ({M}Ks) by using the cipher key (Ks), thereby obtaining the data (M).

In accordance with the present invention, the cipher key Ks used to encipher the data M requested by a communication terminal can only be obtained by decoding the personal secret key {Ks}Kh generated in accordance with an enciphering operation of the Ks enciphering unit, by using the hidden secret key Kh intrinsically assigned to the communication terminal. Accordingly, although enciphered data is circulated over public networks, its original data can be secured. Thus, an improvement in data security is achieved.

### BRIEF DESCRIPTION OF THE DRAWINGS

The above objects and advantages of the present invention will become more apparent by describing in detail preferred embodiments thereof with reference to the attached drawings in which:

FIG. 1 is a block diagram illustrating a data service providing apparatus according to a preferred embodiment of the present invention;

FIG. 2 is a flow chart illustrating a data service providing method according to a preferred embodiment of the present invention using the data service providing apparatus;

FIG. 3 is a block diagram illustrating a detailed configuration of a communication terminal shown in FIG. 1;

FIG. 4 is a block diagram illustrating a detailed configuration of a security deciphering module shown in FIG. 3; and

FIG. 5 is a flow chart illustrating a method for deciphering enciphered data by using the security deciphering apparatus in accordance with a preferred embodiment of the present invention.

### DETAILED DESCRIPTION OF THE PREFERRED EMBODIMENT

Now, preferred embodiments of the present invention will be described in detail with reference to the annexed drawings. In the drawings, the same or similar elements are denoted by the same reference numerals even though they are depicted in different drawings. In the following description made in conjunction with a preferred embodiment of the present invention, a variety of specific elements such as constituting elements of various concrete circuits are described. The description of such elements has been made only for a better understanding of the present invention. Those skilled in the art will appreciate that the present invention can be implemented without using the above mentioned specific elements. In the following description of the present invention, a detailed description of known functions and configurations incorporated herein will be omitted when it may obscure the subject matter of the present invention.

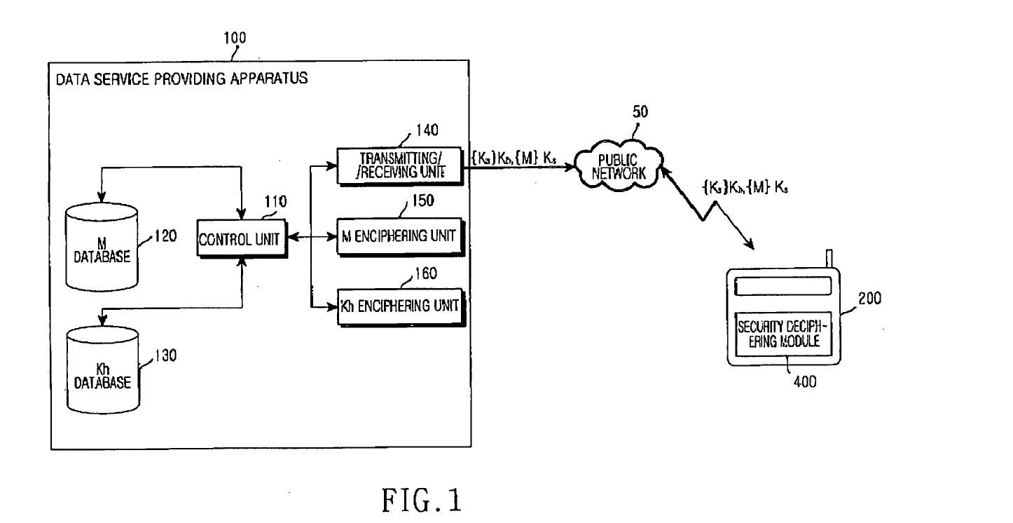

FIG. 1 is a block diagram illustrating a data service providing apparatus according to a preferred embodiment of the present invention. As shown in FIG. 1, the data service providing apparatus, which is denoted by the reference numeral 100, includes a control unit 110, a database 120 for storing data M (hereinafter, referred to as an “M database”, a database 130 for storing hidden secret keys Kh (hereinafter, referred to as a “Kh database”), a transmitting/receiving unit 140, an enciphering unit 150 for data M (hereinafter, referred to as an “M enciphering unit”), and an enciphering unit 160 for a cipher key Ks (hereinafter, referred to as a “Ks enciphering unit”). [PLEASE CORRECT FIG. 1 AS SHOWN.] The data service providing apparatus 100 communicates with a communication terminal 200 via a public network 50.

The control unit 110 controls the operation of the data service providing apparatus 100. The M database 120 stores data M to be supplied to the communication terminal 200, and transfers the stored data M to the control unit 110 under the control of the control unit 110. Generally, the data M includes commercial data and secured data. The Kh database 130 stores hidden secret keys Kh each corresponding to intrinsic identification (ID) information of a security deciphering module 400 equipped in the communication terminal 200, and adapted to decipher enciphered data. The Kh database 130 transfers a selected one of the stored hidden secret keys Kh to the control unit 110 under the control of the control unit 110.

The transmitting/receiving unit 140 communicates with the communication terminal 200 via the public network 50 under the control of the control unit 110. The M enciphering unit 150 enciphers the data M stored in the data database 120, using a cipher key Ks, under the control of the control unit 110. The Ks enciphering unit 160 enciphers the cipher key Ks used to encipher the data M, using the hidden secret key Kh stored in the Kh database 130, under the control of the control unit 110.

The transmitting/receiving unit 140 transmits enciphered data outputted from the M enciphering unit 150, that is, enciphered data {M}Ks, and an enciphered cipher key outputted from the Ks enciphering unit 160, that is, a personal secret key {Ks}Kh ({Ks}Kh=Kp), to the communication terminal 200 requesting the data M via the public network 50.

As the enciphered data {M}Ks and personal secret key {Ks}Kh generated in accordance with respective enciphering operations of the M enciphering unit 150 and Ks enciphering unit 160 are transmitted to the communication terminal 200 via the public network 50, it is possible for the data to be made commercially available while maintaining its security.

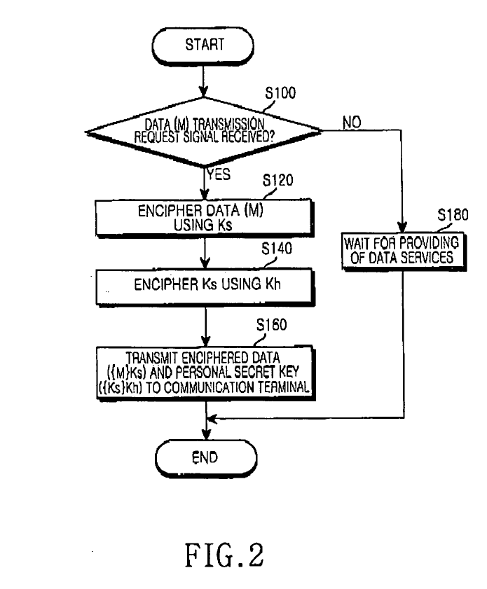

FIG. 2 is a flow chart illustrating a data service providing method according to a preferred embodiment of the present invention using the data service providing apparatus having the above described configuration.

In accordance with the data service providing method, the control unit 110 first determines whether or not there is a data request signal requesting transmission of the data M received from a communication terminal, for example, the communication terminal 200, via the transmitting/receiving unit 140 (Step S100). When it is determined that no data request signal is received, the control unit 110 is maintained in a state of waiting for providing of data services (Step S180).

When it is determined that the data request signal is received, the control unit 110 reads out the data M meeting the data request from the M database 120, and then controls the M enciphering unit 150 in order to encipher the read-out data M by a predetermined cipher key Ks (Step S120). The control unit 110 reads out, from the Kh database 130, a hidden secret key Kh corresponding to the intrinsic ID information of the security deciphering module 400 included in the communication terminal 200, and then controls the Ks enciphering unit 160 in order to encipher the cipher key Ks used to encipher the data M (Step S140).

The control unit 110 controls the transmitting/receiving unit 140 in order to transmit the enciphered data {M}Ks and personal secret key {Ks}Kh to the communication terminal 200 via the public network 50 (Step S160). In accordance with the control operation of the control unit 110, the transmitting/receiving unit 140 transmits the enciphered data {M}Ks and personal secret key {Ks}Kh to the communication terminal 200 via the public network 50.

Thus, it is possible for the data to be made commercially available while maintaining its security because the enciphered data {M}Ks and personal secret key {Ks}Kh generated in accordance with respective enciphering operations of the M enciphering unit 150 and Ks enciphering unit 160 are transmitted to the communication terminal 200 via the public network 50.

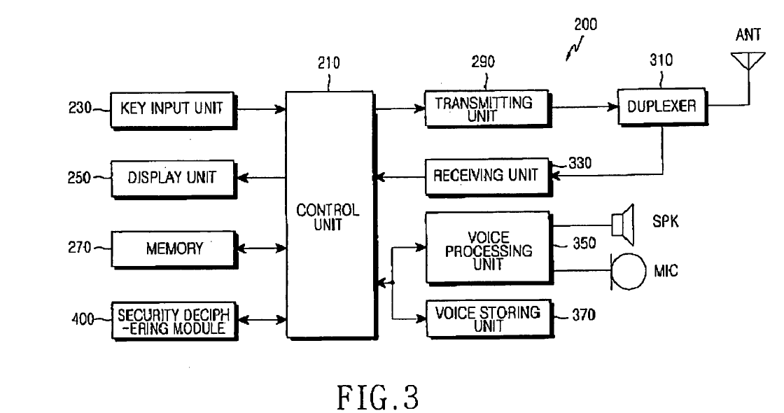

FIG. 3 is a block diagram illustrating a detailed configuration of the communication terminal 200 shown in FIG. 1. [PLEASE CORRECT FIG. 3 AS SHOWN.] As shown in FIG. 3, the communication terminal 200 includes a control unit 210, a key input unit 230, a display unit 250, a memory 270, a transmitting unit 290, a receiving unit 330, a duplexer 310, a voice processing unit 350, and a voice storing unit 370, in addition to the security deciphering module 400. Also shown are speaker SPK, microphone MIC, and antenna ANT.

The control unit 210 controls the whole operation of the communication terminal 200. The key input unit 230 includes at least a plurality of dialing digit keys, a menu key, and a send key. The key input unit 230 generates a key signal corresponding to a key selected by the user, and transfers the key signal to the control unit 210. The display unit 250 may comprise an LCD or LED. This display unit 250 displays control data and input data generated in association with an operation of the communication terminal 200 carried out under the control of the control unit 210.

The memory 270 stores a control program for the communication terminal 200 and the control data generated in accordance with the control operation of the control unit 210. The security deciphering module 400 deciphers the enciphered data {M}Ks and personal secret key {Ks}Kh transmitted from the data service providing apparatus 100, thereby recovering data M. The transmitting unit 290 receives a signal generated from the control unit 210, modulates the received signal into a digital radio signal, and transfers the radio signal to the duplexer 310. The duplexer 310 sends out the radio signal received from the transmitting unit 290 via the antenna, and transfers a signal received via the antenna to the receiving unit 330. The receiving unit 330 demodulates the radio signal received from the duplexer 310, and transfers the demodulated signal to the control unit 210 which, in turn, controls an operation of the communication terminal 200 associated with call services, in response to the demodulated signal.

The voice processing unit 350 processes a voice message read out from the voice storing unit 370 to generate a corresponding analog signal, and outputs the analog signal through the speaker. The voice processing unit 350 also processes an analog voice inputted by the user through the microphone to generate a corresponding digital signal. The voice storage unit 370 stores a plurality of voice messages therein.

In accordance with the above described configuration, when a data transmission request signal is inputted through the key input unit 230, the control unit 210 transfers the data transmission request signal to the data service providing apparatus 100 via the transmitting unit 290.

The control unit 210 receives enciphered data {M}Ks and a personal secret key {Ks}Kh transmitted from the data service providing apparatus 100 in response to the data transmission request signal, and deciphers them, thereby recovering data M.

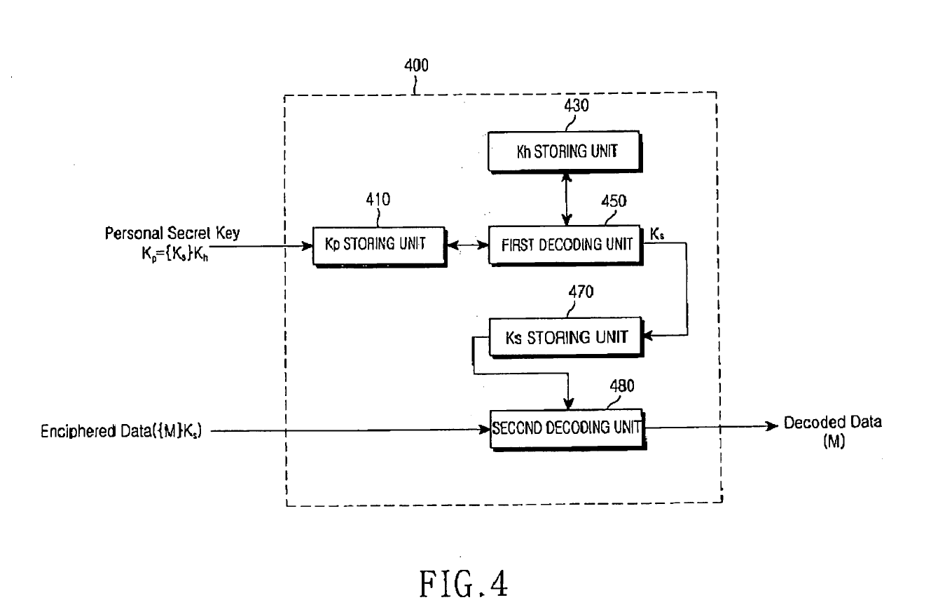

FIG. 4 is a block diagram illustrating a detailed configuration of the security deciphering module 400 shown in FIG. 3. As shown in FIG. 4, the security deciphering module 400 includes a personal secret key (Kp) storing unit 410, a hidden secret key (Kh) storing unit 430, a first decoding unit 450, a cipher key (Ks) storing unit 470, and a second decoding unit 490.

The Kp storing unit 410 stores a personal secret key {Ks}Kh transmitted from the transmitting/receiving unit 140 of the data service providing apparatus 100 shown in FIG. 1 and received by the receiving unit 330 of the communication terminal 200. Under the control of the first decoding unit 450, the personal secret key {Ks}Kh stored in the Kp storing unit 410 is subsequently outputted to the first decoding unit 450. The Kh storing unit 430 stores a hidden secret key Kh corresponding to the intrinsic ID information assigned to the security deciphering module 400. Using the hidden secret key Kh stored in the Kh storing unit 430, the first decoding unit 450 decodes the personal secret key {Ks}Kh received from the Kp storing unit 410, as expressed by the following Expression 1, thereby generating decoded data, that is, a cipher key Ks. As described above, the personal secret key {Ks}Kh is enciphered data generated in accordance with an enciphering operation of the Ks enciphering unit 160 of the data service providing apparatus 100 carried out for the cipher key Ks.

{{Ks}Kh}Kh=Ks Expression 1

The Ks storing unit 470 stores the decoded data outputted from the first decoding unit 450, that is, the cipher key Ks. Under the control of the second decoding unit 490, the cipher key Ks stored in the Ks storing unit 470 is subsequently transferred to the second decoding unit 490. Using the cipher key Ks outputted from the Ks storing unit 470, the second decoding unit 490 decodes enciphered data {M}Ks generated from the M enciphering unit 150 of the data service providing apparatus 100, as expressed by the following Expression 2.

{{M}Ks}Ks=M Expression 2

The decoded data, that is, data M, is transferred to the control unit 210 of FIG. 3 which, in turn, outputs the data M to the display unit 250 and voice processing unit 350 in accordance with associated processes, respectively.

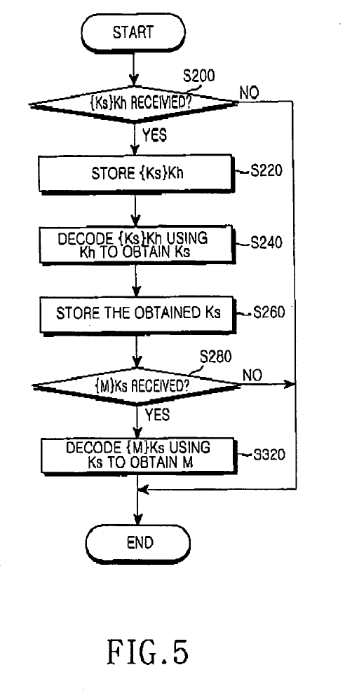

FIG. 5 is a flow chart illustrating a method for deciphering enciphered data by using the above described security deciphering apparatus in accordance with a preferred embodiment of the present invention. In accordance with this method, the control unit 210 of the communication terminal 200 first determines whether or not there is a personal secret key {Ks}Kh ({Ks}Kh=Kp) received from the data service providing apparatus 100 (Step S200). When it is determined that the personal secret key {Ks}Kh is received, the control unit 210 stores the personal secret key {Ks}Kh in the Kp storing unit 410 (Step 220).

The first decoding unit 450 then decodes the personal secret key {Ks}Kh stored in the Kp storing unit 410, using the hidden secret key Kh stored in the Kh storing unit 430, thereby generating decoded data, that is, a cipher key Ks (Step S240). The cipher key Ks generated from the first decoding unit 450 is stored in the Ks storing unit 470 (Step S260).

The control unit 210 subsequently determines whether or not there is enciphered data {M}Ks received from the data service providing apparatus 100 (Step 280). When it is determined that the enciphered data {M}Ks is received, the second decoding unit 490 decodes the enciphered data {M}Ks, using the cipher key Ks stored in the Ks storing unit 470, thereby generating decoded data, that is, data M (Step S320).

The control unit 210 outputs the data M to the display unit 270 and/or the voice processing unit 350 in accordance with the type of the data M.

Thus, it is possible to receive the data M in a secured state as the data M is recovered in accordance with the decoding operations for the enciphered data {M}Ks and personal secret key {Ks}Kh carried out by the first and second decoding units 450 and 490.

As apparent from the above description, the cipher key Ks used to encipher the data M requested by a communication terminal can only be obtained by decoding the personal secret key {Ks}Kh generated in accordance with an enciphering operation of the Ks enciphering unit, by using the hidden secret key Kh intrinsically assigned to the communication terminal. Accordingly, although enciphered data is circulated over public networks, its original data can be secured. Thus, an improvement in data security is achieved.

While this invention has been described in connection with what is presently considered to be the most practical and preferred embodiment, it is to be understood that the invention is not limited to the disclosed embodiment, but, on the contrary, it is intended to cover various modifications within the spirit and scope of the appended claims.

What is claimed is:

1. A security deciphering apparatus comprising:
a hidden secret key storing unit for storing a hidden secret key (Kh) corresponding to intrinsic identification information;
a first decoding unit for receiving via a public network a personal secret key ({Ks}Kh), generated by enciphering a cipher key (Ks) by using the hidden secret key (Kh), and decoding the personal secret key ({Ks}Kh) by using the hidden secret key (Kh), thereby obtaining the cipher key (Ks); and
a second decoding unit for receiving via the public network enciphered data ({M}Ks), generated by enciphering data (M) by using the cipher key (Ks), and decoding the enciphered data ({M}Ks) by using the cipher key (Ks), thereby obtaining the data (M).

2. The security deciphering apparatus according to claim 1, further comprising:
a personal secret key storing unit for storing the personal secret key ({Ks}Kh) received via the public network, and outputting the stored personal secret key ({Ks}Kh) to the first decoding unit under a control of the first decoding unit; and
a cipher key storing unit for storing the cipher key (Ks) obtained by the first decoding unit, and outputting the stored cipher key (Ks) to the second decoding unit under a control of the second decoding unit.

3. A data service providing apparatus for providing data requested by a communication terminal, comprising:
a data database for storing data (M) to be provided to the communication terminal;
a hidden secret key database for storing a hidden secret key (Kh) corresponding to intrinsic identification information of a security deciphering module equipped in the communication terminal to decipher enciphered data;
a transmitting/receiving unit for performing communication with the communication terminal via a public network;
a data enciphering unit for enciphering the data (M) by using a cipher key (Ks);
a cipher key enciphering unit for enciphering the cipher key (Ks) by using the hidden secret key (Kh); and
a control unit for controlling the enciphering operations of the data and cipher key enciphering units, and controlling the transmitting/receiving unit to provide the enciphered data ({M}Ks) and the personal secret key ({Ks}Kh) via the public network.

4. The data service providing apparatus according to claim 3, wherein the security deciphering module comprises:
a hidden secret key storing unit for storing the hidden secret key (Kh) corresponding to the intrinsic identification information of the security deciphering module;
a first decoding unit for decoding the personal secret key ({Ks}Kh) provided by the transmitting/receiving unit, by using the hidden secret key (Kh), thereby obtaining the cipher key (Ks); and
a second decoding unit for decoding the enciphered data ({M}Ks) provided by the transmitting/receiving unit, by using the cipher key (Ks), thereby obtaining the data (M).

5. The data service providing apparatus according to claim 4, wherein the security deciphering module further comprises:
a personal secret key storing unit for storing the personal secret key ({Ks}Kh) provided by the transmitting/receiving unit, and outputting the stored personal secret key ({Ks}Kh) to the first decoding unit under a control of the first decoding unit; and
a cipher key storing unit for storing the cipher key (Ks) obtained by the first decoding unit, and outputting the stored cipher key (Ks) to the second decoding unit under a control of the second decoding unit.

6. A security deciphering method comprising the steps of:
determining whether or not a personal secret key ({Ks}Kh), generated by enciphering a cipher key (Ks) by using a hidden secret key (Kh) corresponding to intrinsic identification information, is received;
if it is determined that the personal secret key ({Ks}Kh) is received, then decoding the received personal secret key ({Ks}Kh) by using the hidden secret key (Kh), thereby obtaining the cipher key (Ks);
determining whether or not enciphered data ({M}Ks), generated by enciphering data (M) requested to be transmitted by using the cipher key (Ks), is received; and
if it is determined that the enciphered data ({M}Ks) is received, then decoding the enciphered data ({M}Ks) by using the cipher key Ks, thereby obtaining the data (M).

7. A data service providing method for providing data requested by a communication terminal, comprising the steps of:
receiving via a public network a request for transmission of data (M) from the communication terminal;
enciphering the data (M) by using a cipher key (Ks) in response to the received data transmission request, thereby generating enciphered data ({M}Ks);
enciphering, in response to the received data transmission request, the cipher key (Ks) by using a hidden secret key (Kh) corresponding to intrinsic identification information assigned to a security enciphering module equipped in the communication terminal to decode the enciphered data ({M}Ks), thereby generating personal secret key ({Ks}Kh); and
transmitting the enciphered data ({M}Ks) and the personal secret key ({Ks}Kh) to the communication terminal via the public network.

8. The data service providing method according to claim 7, wherein the security enciphering module equipped in the communication terminal comprises:
a hidden secret key storing unit for storing the hidden secret key (Kh) corresponding to the intrinsic identification information assigned to the security enciphering module;
a first decoding unit for decoding the personal secret key ({Ks}Kh) by using the hidden secret key (Kh), thereby obtaining the cipher key (Ks); and
a second decoding unit for decoding the enciphered data ({M}Ks) by using the obtained cipher key (Ks), thereby obtaining the data (M).

9. The data service providing method according to claim 8, wherein the security deciphering module further comprises:
a personal secret key storing unit for storing the personal secret key ({Ks}Kh) received by the communication terminal via the public network, and outputting the stored personal secret key ({Ks}Kh) to the first decoding unit under a control of the first decoding unit; and
a cipher key storing unit for storing the cipher key (Ks) obtained by the first decoding unit, and outputting the stored cipher key (Ks) to the second decoding unit under a control of the second decoding unit.

10. In a mobile communication terminal receiving, via a public network, enciphered data ({M}Ks) generated by enciphering data (M) by using a cipher key (Ks), a security deciphering apparatus comprising:
a hidden secret key storing unit for storing a hidden secret key (Kh) corresponding to intrinsic identification information assigned to the mobile communication terminal;
a first decoding unit for receiving a personal secret key ({Ks}Kh), generated by enciphering a cipher key (Ks) by using the hidden secret key (Kh), and decoding the personal secret key ({Ks}Kh) by using the hidden secret key (Kh), thereby obtaining the cipher key (Ks); and
a second decoding unit for decoding the enciphered data ({M}Ks) by using the cipher key (Ks), thereby obtaining the data (M).
